(19) United States
(12) Patent Application Publication
(10) Pub. No.: US 2012/0175034 A1
(43) Pub. Date: Jul. 12, 2012

(54) Cable with Three Layers, Rubberized On Site, for the Framework of a Tire Carcass

(76) Inventors: Jacques Gauthier, Lempdes (FR); Thibaud Pottier, Clermont-Ferrand (FR)

(21) Appl. No.: 13/376,352

(22) PCT Filed: May 26, 2010
(86) PCT No.: PCT/EP2010/057245

§ 371 Date: Mar. 22, 2012

(30) Foreign Application Priority Data
Jun. 3, 2009 (FR) 0902680

(51) Int. Cl. D02G 3/00; B60C 9/00

(52) U.S. Cl. 152/527; 428/377

(57) ABSTRACT

Metal cord (C-1) with three layers (C1, C2, C3), which is rubberized in situ, comprising a core or first layer (10, C1) of diameter d₁, around which there are wound together in a helix at a pitch p₂, in a second layer (C2), N wires (11) of diameter d₂, around which there are wound together in a helix at a pitch p₃, in a third layer (C3), P wires (12) of diameter d₃, wherein the cord has the following characteristics (d₁, d₂, d₃, p₂ and p₃ being expressed in mm):
0.08≦d₁≦0.50;
0.08≦d₂≦0.45;
0.08≦d₃≦0.45;
5.1π(d₁+d₂)<p₂<p₃<4.9π(d₁+2d₂+d₃);
over any 2 cm length of cord, a rubber composition called “filling rubber” (13) is present in each of the capillaries (14) lying on the one hand between the core (C1) and the N wires (11) of the second layer (C2), and on the other hand between the N wires (11) of the second layer (C2) and the P wires (12) of the third layer (C3);
the content of filling rubber (13) in the cord is comprised between 10 and 50 mg per gram of cord.

Multi-strand cord at least one of the strands of which is a three-layered metal cord (C-1) rubberized in situ.

The present invention relates to three-layer metallic cords that can be used notably for reinforcing articles made of rubber, and more particularly relates to three-layer metallic cords of the type “rubberized in situ”, i.e. cords that are rubberized from the inside, during their actual manufacture, with rubber in the uncured state.

It also relates to the use of such cords in tires and particularly in the carcass reinforcements thereof, also called “carcasses”, and more particularly to the reinforcement of the carcasses of tires for industrial vehicles.

As is known, a radial tire comprises a tread, two inextensible beads, two sidewalls connecting the beads to the tread and a belt positioned circumferentially between the carcass reinforcement and the tread. This carcass reinforcement is made up in the known way of at least one ply (or “layer”) of rubber which is reinforced with reinforcing elements (“reinforcers”) such as cords or monofilaments, generally of the metallic type in the case of tires for industrial vehicles.

To reinforce the above carcass reinforments, use is generally made of what are known as “layered” steel cords made up of a central layer or core and one or more concentric layers of wires positioned around this core. The three-layered cords most often used are essentially cords of M+N+P construction formed of a core of M wire(s), M varying from 1 to 4, surrounded by an intermediate layer of N wires, N typically varying from 3 to 12, itself surrounded by an outer layer of P wires, P typically varying from 8 to 20, it being possible for the entire assembly to be wrapped with an external wrapper wound in a helix around the outer layer.

As is well known, these layered cords are subjected to high stresses when the tires are running along, notably to repeated bendings or variations in curvature which, at the wires, give rise to friction, notably as a result of contact between adjacent layers, and therefore to wear, as well as fatigue; they therefore have to have high resistance to what is known as “fretting fatigue”.

It is also particularly important for them to be impregnated as far as possible with the rubber, for this material to penetrate into all the spaces between the wires that make up the cords. Indeed, if this penetration is insufficient, empty channels or capillaries are then formed along and within the cords, and corrosive agents, such as water or even the oxygen in the air, liable to penetrate the tires, for example as a result of cuts in their treads, travel along these empty channels into the carcass of the tire. The presence of this moisture plays an important role in causing corrosion and accelerating the above degradation processes (the so-called “corrosion fatigue” phenomena), as compared with use in a dry atmosphere.

All these fatigue phenomena that are generally grouped under the generic term “fretting corrosion fatigue” cause progressive degeneration of the mechanical properties of the cords and may, under the severest running conditions, affect the life of these cords.

To alleviate the above disadvantages, application WO 2005/071157 has proposed three-layered cords of 1+M+N construction, particularly of 1+6+12 construction, one of the essential features of which is that a sheath consisting of a diene rubber composition covers at least the intermediate layer made up of the M wires, it being possible for the core of the cord itself either to be covered or not to be covered with rubber. Thanks to this special design, not only is excellent rubber penetrability obtained, limiting problems of corrosion, but the fretting fatigue endurance properties are also notably improved over the cords of the prior art. The longevity of the heavy goods vehicle tires and that of their carcass reinforcements are thus very appreciably improved.

However, the described methods for the manufacture of these cords, and the resulting cords themselves, are not free of disadvantages.

First of all, these three-layer cords are obtained in several steps which have the disadvantage of being discontinuous, firstly involving creating an intermediate 1+M (particularly 1+6) cord, then sheathing this intermediate cord using an extrusion head, and finally a final operation of cabling the remaining N (particularly 12) wires around the core thus sheathed, in order to form the outer layer. In order to avoid the problem of the very high tack of uncured rubber of the rubber sheath before the outer layer is cabled around the core, use must also be made of a plastic interlayer film during the intermediate spooling and unspooling operations. All these successive handling operations are punitive from the industrial standpoint and go counter to achieving high manufacturing rates.

Further, if there is a desire to ensure a high level of penetration of the rubber into the cord in order to obtain the lowest possible air permeability of the cord along its axis, it has been found that it is necessary using these methods of the prior art to use relatively high quantities of rubber during the sheathing operation. Such quantities lead to more or less pronounced unwanted overspill of uncured rubber at the periphery of the as-manufactured finished cord.

Now, as has already been mentioned hereinabove, because of the very high tack that rubber in the uncured state has, such unwanted overspill in turn gives rise to appreciable disadvantages during later handling of the cord, particularly during the calendering operations which will follow for incorporating the cord into a strip of rubber, likewise in the uncured state, prior to the final operations of manufacturing the tire and final curing.

All of the above disadvantages of course slow down the industrial production rates and have an adverse effect on the final cost of the cords and of the tires they reinforce.

While pursuing their research, the Applicants have discovered an improved three-layered cord obtained by using a specific method of manufacture which is able to alleviate the abovementioned drawbacks.

Accordingly, a first subject of the invention is a metal cord with three layers (C1, C2, C3), which is rubberized in situ, comprising a core or first layer (C1) of diameter d₁, around which there are wound together in a helix at a pitch p₂, in a second layer (C2), N wires of diameter d₂, around which there are wound together in a helix at a pitch p₃, in a third layer (C3), P wires of diameter d₃, the said cord being characterized in that it has the following characteristics (d₁, d₂, d₃, p₂ and p₃ being expressed in mm):
0.08≦d₁≦0.50;
0.08≦d₂≦0.45;
0.08≦d₃≦0.45;
5.1π(d₁+d₂)<p₂<p₃<4.9π(d₁+2d₂+d₃);
over any 2 cm length of cord, a rubber composition called “filling rubber” is present in each of the capillaries lying on the one hand between the core (C1) and the N wires of the second layer (C2), and on the other hand between the N wires of the second layer (C2) and the P wires of the third layer (C3);
the content of filling rubber in the cord is comprised between 10 and 50 mg per gram of cord.

Due to its different pitches p₂ and p₃, this three-layered cord is of the type with cylindrical layers, as opposed to cords of the compact type obtained when the pitches p₂ and p₃ are identical and when furthermore the directions of twisting of the layers C2 and C3 are the same.

This three-layered cord of the invention, when compared with the three-layered cords rubberized in situ of the prior art, has the notable advantage of containing a smaller and controlled amount of filling rubber, this rubber also being distributed uniformly inside the cord, inside each of its capillaries, thus giving it optimum impermeability along its axis.

The invention also relates to the use of such a cord for reinforcing semifinished products or articles made of rubber, for example plies, hoses, belts, conveyor belts and tires.

The cord of the invention is most particularly intended to be used as a reinforcing element for a carcass reinforcement of a tire for industrial vehicles (which bear heavy loads), such as vans and vehicles known as heavy goods vehicles, that is to say underground rail vehicles, buses, heavy road transport vehicles such as lorries, tractors, trailers or even off-road vehicles, agricultural or civil engineering machinery and any other type of transport or handling vehicle.

The invention also relates to these semifinished products or articles made of rubber themselves when they are reinforced with a cord according to the invention, particularly the tires intended for industrial vehicles such as vans or heavy goods vehicles.

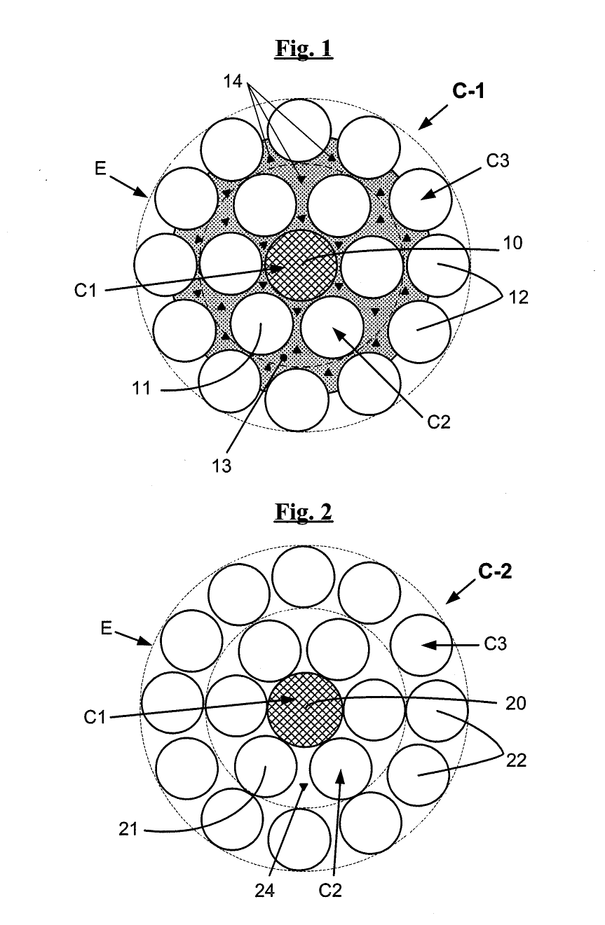

The invention and its advantages will be readily understood in the light of the following description and embodiments, and from FIGS. 1 to 4 which relate to these embodiments and which respectively diagrammatically depict:

in cross section, a cord of 1+6+12 construction according to the invention, rubberized in situ (FIG. 1);

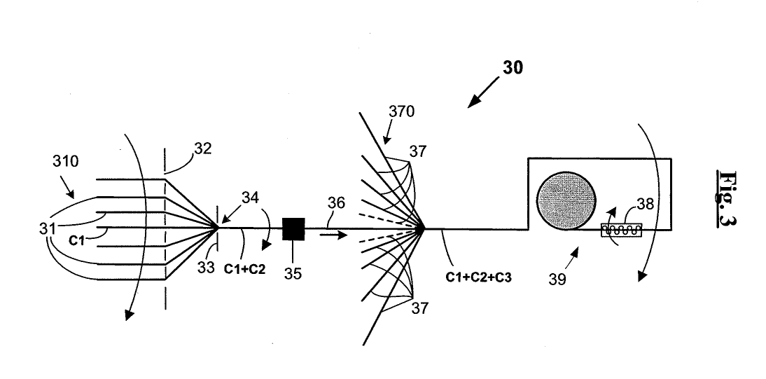

in cross section, a conventional cord of 1+6+12 construction, not rubberized in situ (FIG. 2);

an example of an in situ rubberizing and twisting installation that can be used for manufacturing cords according to the invention (FIG. 3);

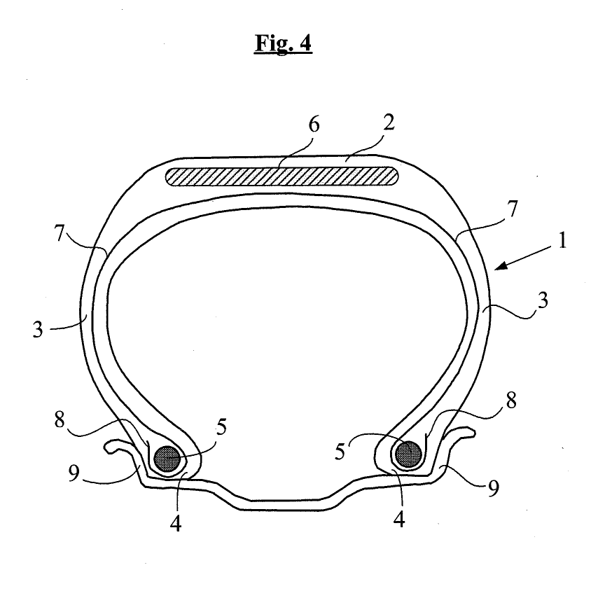

in radial section, a heavy goods vehicle tire casing with radial carcass reinforcement, which may or may not in this generalized depiction be according to the invention (FIG. 4).

### I. MEASUREMENTS AND TESTS

### I-1. Dynamometric Measurements

As regards the metal wires and cords, measurements of the breaking strength denoted Fm (maximum load in N), tensile strength denoted Rm (in MPa) and elongation at break, denoted At (total elongation in %) are carried out in tension in accordance with standard ISO 6892 of 1984.

As regards the rubber compositions, the modulus measurements are carried out under tension, unless otherwise indicated, in accordance with standard ASTM D 412 of 1998 (specimen “C”): the “true” secant modulus (i.e. the modulus with respect to the actual cross section of the specimen) at 10% elongation, denoted E10 and expressed in MPa, is measured on second elongation (that is to say, after one accommodation cycle) (normal temperature and moisture conditions in accordance with standard ASTM D 1349 of 1999).

### I-2. Air Permeability Test

This test enables the longitudinal air permeability of the tested cords to be determined by measuring the volume of air passing through a specimen under constant pressure over a given time. The principle of such a test, well known to those skilled in the art, is to demonstrate the effectiveness of the treatment of a cord in order to make it impermeable to air. The test is described, for example, in standard ASTM D2692-98.

The test is carried out here either on cords extracted from tires or from the rubber plies that they reinforce, which have therefore already been coated from the outside with cured rubber, or on as-manufactured cords.

In the latter instance, the as-manufactured cords have first of all to be coated from the outside by a rubber known as a coating rubber. To do this, a series of ten cords arranged parallel to one another (with an inter-cord distance of 20 mm) is placed between two layers (two rectangles measuring 80×200 mm) of an uncured rubber composition, each layer having a thickness of 3.5 mm; the whole assembly is then clamped in a mould, each of the cords being kept under sufficient tension (for example 2 daN) to ensure that it remains straight while being placed in the mould, using clamping modules; the vulcanizing (curing) process then takes place over 40 minutes at a temperature of 140° C. and under a pressure of 15 bar (applied by a rectangular piston measuring 80×200 mm). After that, the assembly is demoulded and cut up into 10 specimens of cords thus coated, in the form of parallelepipeds measuring 7×7×20 mm, for characterization.

A conventional tire rubber composition is used as coating rubber, the said composition being based on natural (peptized) rubber and N330 carbon black (60 phr), also containing the following usual additives: sulphur (7 phr), sulfenamide accelerator (1 phr), ZnO (8 phr), stearic acid (0.7 phr), antioxidant (1.5 phr) and cobalt naphthenate (1.5 phr) (phr signifying parts by weight per hundred parts of rubber); the modulus E10 of the coating rubber is about 10 MPa.

The test is carried out on 2 cm lengths of cord, hence coated with its surrounding rubber composition (or coating rubber) in the cured state, as follows: air under a pressure of 1 bar is injected into the inlet of the cord and the volume of air leaving it is measured using a flow meter (calibrated for example from 0 to 500 cm³/min). During measurement, the cord specimen is immobilized in a compressed airtight seal (for example a dense foam or rubber seal) so that only the quantity of air passing through the cord from one end to the other along its longitudinal axis is measured; the airtightness of the airtight seal is checked beforehand using a solid rubber specimen, that is to say one containing no cord.

The higher the longitudinal impermeability of the cord, the lower the measured average air flow rate (averages over 10 specimens). Since the measurement is accurate to ±0.2 cm³/min, measured values equal to or lower than 0.2 cm³/min are considered to be zero; they correspond to a cord that can be termed airtight (completely airtight) along its axis (i.e. in its longitudinal direction).

### I-3. Filling Rubber Content

The amount of filling rubber is measured by measuring the difference between the weight of the initial cord (therefore the in-situ rubberized cord) and the weight of the cord (and therefore that of its wires) from which the filling rubber has been removed using an appropriate electrolytic treatment.

A cord specimen (1 m in length), coiled on itself to reduce its size, constitutes the cathode of an electrolyser (connected to the negative terminal of a generator) while the anode (connected to the positive terminal) consists of a platinum wire.

The electrolyte consists of an aqueous (demineralised water) solution containing 1 mol per litre of sodium carbonate.

The specimen, completely immersed in the electrolyte, has voltage applied to it for 15 minutes with a current of 300 mA. The cord is then removed from the bath and abundantly rinsed with water. This treatment enables the rubber to be easily detached from the cord (if this is not so, the electrolysis is continued for a few minutes). The rubber is carefully removed, for example by simply wiping it using an absorbent cloth, while untwisting the wires one by one from the cord. The wires are once again rinsed with water and then immersed in a beaker containing a mixture of demineralised water (50%) and ethanol (50%); the beaker is immersed in an ultrasonic bath for 10 minutes. The wires thus stripped of all traces of rubber are removed from the beaker, dried in a stream of nitrogen or air, and finally weighed.

From this is deduced, by calculation, the filling rubber content of the cord, expressed in mg (milligrams) of filling rubber per g (gram) of initial cord averaged over 10 measurements (i.e. over 10 metres of cord in total).

### II. DETAILED DESCRIPTION OF THE INVENTION

In the present description, unless expressly indicated otherwise, all the percentages (%) indicated are percentages by weight.

Moreover, any range of values denoted by the expression “between a and b” represents the range of values extending from more than a to less than b (i.e. excluding the end points a and b), whereas any range of values denoted by the expression “from a to b” means the range of values extending from a to b (i.e. including the strict end points a and b).

### II-1. Cord of the Invention

The metal cord of the invention therefore comprises three concentric layers:
a first layer (C1) of diameter d₁;
a second layer (C2) comprising N wires of diameter d₂ wound together in a helix at a pitch p₂ around the first layer;
a third layer (C3) comprising P wires of diameter of diameter d₃, wound together in a helix at a pitch p₃ around the second layer.

In a known way, the first layer is also known as the core of the cord, while the first and second layers together form what is customarily known as the centre of the cord.

This cord of the invention also has the following essential characteristics (d₁, d₂, d₃, p₂ and p₃ being expressed in mm):
0.08≦d₁≦0.50;
0.08≦d₂≦0.45;
0.08≦d₃≦0.45;
5.1π(d₁+d₂)<p₂<p₃<4.9π(d₁+2d₂+d₃);
for any 2 cm length of cord, a rubber composition called “filling rubber” is present in each of the capillaries lying on the one hand between the core (C1) and the N wires of the second layer (C2), and on the other hand between the N wires of the second layer (C2) and the P wires of the third layer (C3);
the content of filling rubber in the cord is comprised between 10 and 50 mg per gram of cord.

This cord of the invention can be termed an in-situ-rubberized cord, that is to say it is rubberized inside, during its actual manufacture (hence in the raw manufacturing state), by the filling rubber. Stated otherwise, each of the capillaries or gaps (the two interchangeable terms denoting the voids, empty spaces in the absence of filling rubber) formed by the adjacent wires, taken in threes, of its three layers C1, C2 and C3 is at least partially (continuously or otherwise along the axis of the cord), filled with the filling rubber such that for any 2 cm length of cord, each capillary comprises at least one plug of rubber.

The other essential feature of the cord of the invention is that its filling rubber content is comprised between 10 and 50 mg of rubber per g of cord. Below the indicated minimum, it is not possible to guarantee that, for any at least 2 cm length of cord, the filling rubber will be correctly present, at least in part, in each of the gaps of the cord, whereas above the indicated maximum, the cord is exposed to the various problems described hereinabove which are due to the overspilling of filling rubber at the periphery of the cord. For all of these reasons, it is preferable for the filling rubber content to be comprised between 15 and 50 mg, more preferably between 20 and 45 mg per g of cord.

Such a filling rubber content and keeping it within the above defined limits is made possible only by the use of a special twisting-rubberizing process suited to the geometry of the cord, and which will be explained in detail later.

Use of this specific process, while at the same time making it possible to obtain a cord in which the quantity of filling rubber is controlled, guarantees that internal partitions (which are continuous or discontinuous along the axis of the cord) or plugs of rubber will be present in the cord of the invention, and will be so in sufficient number; thus, the cord of the invention becomes impervious to the spread, along the cord, of any corrosive fluid such as water or the oxygen in the air, thus eliminating the wicking effect described in the introduction of this text.

Thus, the following feature is preferably satisfied: over any 2 cm length of cord, the cord is airtight or practically airtight in the longitudinal direction. In other words, each capillary (or cavity) of the cord comprises at least one plug (or internal partition) of filling rubber over this 2 cm length so that the said cord (once coated from the outside with a polymer such as rubber) is airtight or practically airtight in its longitudinal direction.

In the air permeability test described in paragraph I-2, a cord said to be “airtight” in the longitudinal direction is characterized by an average air flow rate less than or at most equal to 0.2 cm³/min whereas a cord said to be “practically airtight” in the longitudinal direction is characterized by an average air flow rate of less than 2 cm³/min, preferably of less than 1 cm³/min.

The core (C1) of the cord of the invention is preferably made up a single individual wire or at most two wires, it being possible for example for the latter either to be parallel or twisted together. However, more preferably, the core (C1) of the cord of the invention consists of a single individual wire. The layer C2, for its part, preferably comprises 5 to 7 wires (i.e. N equal to 5, 6 or 7).

For an optimized compromise between strength, feasibility, rigidity and flexural durability of the cord, it is preferable for the diameters of the wires in the layers C1, C2 and C3, whether or not these wires have the same diameter from one layer to the next, to satisfy the following relationships (d₁, d₂, d₃ being expressed in mm):
0.10≦d₁≦0.40;
0.10≦d₂≦0.35;
0.10≦d₃≦0.35.

More preferably still, the following relationships are satisfied:
0.10≦d₁≦0.35;
0.10≦d₂≦0.30;
0.10≦d₃≦0.30.

According to another particular embodiment, the following characteristics are satisfied:
for N=5: 0.6<(d₁/d₂)<0.9;
for N=6: 0.9<(d₁/d₂)<1.3;
for N=7: 1.3<(d₁/d₂)<1.6.

The wires in layers C2 and C3 may have the same diameter or different diameters from one layer to the next; use is preferably made of wires of the same diameter from one layer to the next (namely d₂=d₃), as this notably simplifies manufacture and reduces the cost of the cords.

For preference, the following relationship is satisfied:

5.2π(d₁+d₂)<p₂<p₃<4.8π(d₁+2d₂+d₃).

It will be recalled here that, in the known way, the pitch “p” represents the length, measured parallel to the axis of the cord, after which a wire that has this pitch has made a complete turn around the said axis of the cord.

The pitches p₂ and p₃ are more preferably chosen in a range from 5 to 30 mm, more preferably still in a range from 5 to 20 mm, particularly when d₂=d₃.

When the core (C1) consists of more than one wire (M different from 1), the M wires are preferably twisted according to a pitch p₁ which lies in a range of 3 to 30 mm, in particular in a range of 3 to 20 mm.

An essential characteristic of the cord of the invention is that the pitch p₂ of the layer is less than the pitch p₃. In a manner well known to a person skilled in the art, a cord said to be of the cylindrical layer type is thus obtained, as opposed to cords of the compact type obtained when the pitches p₂ and p₃ and also the directions of twisting are identical from one layer to another. By thus offsetting the pitches and hence the angles of contact between the wires of the layer C2 on the one hand, and those of the layer C3 on the other hand, the volume of the channels or capillaries between these two layers is increased and its fatigue-fretting performance is further optimized.

This is for example the case of layered cords as depicted schematically in FIG. 1, in which the two layers C2 and C3 can be wound for preference in the same direction of twisting (namely S/S or Z/Z, to use the recognized terminology) or even in opposite directions of twisting (namely S/Z or Z/S). In such cylindrical layered cords, the compactness is such that the layers of wires are readily visible; with a contour (E) which is essentially cylindrical (symbolized by a dotted circle), as illustrated in FIG. 1 (1+6+12 cord according to the invention) or in FIG. 2 (control 1+6+12 cord, i.e. one that has not been rubberized in situ).

Preferably, the third layer or outer layer C3 is a saturated layer, i.e. by definition, there is not enough space in this layer for at least one (Pₘₐₓ+1)th wire of diameter d₃ to be added, Pₘₐₓ representing the maximum number of wires that can be wound in a layer around the second layer C2. This construction has the notable advantage of further limiting the risk of overspill of filling rubber at its periphery and, for a given cord diameter, of offering greater strength.

Thus, the number P of wires can vary to a very large extent according to the particular embodiment of the invention, it being understood that the maximum number of wires P will be increased if their diameter d₃ is reduced by comparison with the diameter d₂ of the wires of the second layer, in order preferably to keep the outer layer in a saturated state.

According to a more preferred embodiment, the layer C3 contains from 10 to 14 wires; of the abovementioned cords those more particularly selected are those consisting of wires that have substantially the same diameter from layer C2 to layer C3 (namely d₂=d₃).

According to a particularly preferred embodiment, the first layer comprises a single wire, the second layer (C2) comprises 6 wires (N equal to 6) and the third layer (C3) comprises 11 or 12 wires (P equal to 11 or 12). In other words, the cord of the invention has the preferential construction 1+6+11 or 1+6+12.

For preference, the two layers C2 and C3, and more preferably the layer C1 where the latter is made up of several wires, are wound in the same direction of twisting, i.e. either in the S direction (“S/S” arrangement), or in the Z direction (“Z/Z” arrangement). Winding these layers in the same direction advantageously minimizes friction between these two layers and therefore wear on the wires of which they are composed.

The construction of the cord of the invention advantageously allows the wrapping wire to be omitted because the rubber better penetrates its structure and gives a self-wrapping effect.

The term “metal cord” is understood by definition in the present application to mean a cord formed from wires consisting predominantly (i.e. more than 50% by number of these wires) or entirely (100% of the wires) of metallic material.

Independently of one another, and from one layer to another, the wire or wires of the core (C1), the wires of the second layer (C2) and the wires of the third layer (C3) are preferably made of steel, more preferably of carbon steel. However, it is of course possible to use other steels, for example a stainless steel, or other alloys.

When a carbon steel is used, its carbon content (% by weight of steel) is preferably comprised between 0.4% and 1.2%, notably between 0.5% and 1.1%; these contents represent a good compromise between the mechanical properties required for the tire and the feasibility of the wires. It should be noted that a carbon content comprised between 0.5% and 0.6% ultimately makes such steels less expensive because they are easier to draw. Another advantageous embodiment of the invention may also consist, depending on the intended applications, in using steels with a low carbon content, comprised for example between 0.2% and 0.5%, particularly because of a lower cost and greater drawability.

The metal or the steel used, whether in particular this is a carbon steel or a stainless steel, may itself be coated with a metal layer which, for example, improves the workability of the metal cord and/or of its constituent elements, or the use properties of the cord and/or of the tire themselves, such as properties of adhesion, corrosion resistance or resistance to ageing. According to one preferred embodiment, the steel used is covered with a layer of brass (Zn—Cu alloy) or of zinc; it will be recalled that, during the wire manufacturing process, the brass or zinc coating makes the wire easier to draw, and makes the wire adhere to the rubber better. However, the wires could be covered with a thin layer of metal other than brass or zinc, having, for example, the function of improving the corrosion resistance of these wires and/or their adhesion to the rubber, for example a thin layer of Co, Ni, Al, an alloy of two or more of the compounds Cu, Zn, Al, Ni, Co, Sn.

The cords of the invention are preferably made of carbon steel and have a tensile strength (Rm) preferably higher than 2500 MPa, more preferably higher than 3000 MPa. The total elongation at break (At) of the cord, which is the sum of its structural, elastic and plastic elongations, is preferably greater than 2.0%, and more preferably still at least equal to 2.5%.

The elastomer (or indiscriminately “rubber”, the two being considered as synonymous) of the filling rubber is preferably a diene elastomer, i.e. by definition an elastomer originating at least in part (i.e. a homopolymer or copolymer) from diene monomer(s) (i.e. monomer(s) bearing two, conjugated or otherwise, carbon-carbon double bonds). The diene elastomer is more preferably chosen from the group consisting of polybutadienes (BR), natural rubber (NR), synthetic polyisoprenes (IR), various copolymers of butadiene, various copolymers of isoprene, and blends of these elastomers. Such copolymers are more preferably chosen from the group consisting of butadiene-stirene copolymers (SBR), whether these are prepared by emulsion polymerization (ESBR) or solution polymerization (SSBR), butadiene-isoprene copolymers (BIR), stirene-isoprene copolymers (SIR) and stirene-butadiene-isoprene copolymers (SBIR).

One preferred embodiment is to use an “isoprene” elastomer, i.e. a homopolymer or copolymer of isoprene, in other words a diene elastomer chosen from the group consisting of natural rubber (NR), synthetic polyisoprenes (IR), various isoprene copolymers and blends of these elastomers. The isoprene elastomer is preferably natural rubber or a synthetic polyisoprene of the cis-1,4 type. Of these synthetic polyisoprenes, use is preferably made of polyisoprenes having a content (in mol %) of cis-1,4 bonds greater than 90%, more preferably still greater than 98%. According to other preferred embodiments, the isoprene elastomer may also be combined with another diene elastomer, such as one of the SBR and/or BR type, for example.

The filling rubber may contain just one elastomer or several elastomers, notably of the diene type, it being possible for this or these to be used in combination with any type of polymer other than an elastomer.

The filling rubber is of the crosslinkable type, i.e. it by definition contains a crosslinking system suitable for allowing the composition to crosslink during its curing process (i.e. so that, when it is heated, it hardens rather than melts); thus this rubber composition may be qualified as unmeltable, because it cannot be melted by heating, whatever the temperature. For preference, in the case of a diene rubber composition, the crosslinking system for the rubber sheath is a system known as a vulcanizing system, i.e. one based on sulphur (or on a sulphur donor agent) and at least one vulcanization accelerator. Various known vulcanization activators may be added to this vulcanizing system. Sulphur is used at a preferred content of between 0.5 and 10 phr, more preferably between 1 and 8 phr. The vulcanization accelerator, for example a sulphenamide, is used at a preferred content of between 0.5 and 10 phr, more preferably between 0.5 and 5.0 phr.

The filling rubber may also contain, in addition to said crosslinking system, all or some of the additives customarily used in the rubber matrixes intended for the manufacture of tires, such as reinforcing fillers such as carbon black or inorganic fillers such as silica, coupling agents, anti-ageing agents, antioxidants, plasticising agents or oil extenders, whether these be of an aromatic or non-aromatic type, especially very weakly or non-aromatic oils, for example of the naphthenic or paraffinic type, with a high or preferably a low viscosity, MES or TDAE oils, plasticizing resins having a high Tg above 30° C., processing aids for making it easier to process the compositions in the uncured state, tackifying resins, anti-reversion agents, methylene acceptors and donors, such as for example HMT (hexamethylene tetramine) or H3M (hexamethoxymethylmelamine), reinforcing resins (such as resorcinol or bismaleimide), known adhesion promoter systems of the metal salt type for example, notably cobalt or nickel salts.

The content of reinforcing filler, for example carbon black or an inorganic reinforcing filler such as silica, is preferably greater than 50 phr, for example comprised between 50 and 120 phr. As carbon blacks, for example, all carbon blacks, particularly of the HAF, ISAF, SAF type conventionally used in tires (known as tire-grade blacks), are suitable. Of these, mention may more particularly be made of carbon blacks of (ASTM) 300, 600 or 700 grade (for example N326, N330, N347, N375, N683, N772). Suitable inorganic reinforcing fillers notably include inorganic fillers of the silica (SiO₂) type, especially precipitated or pyrogenic silicas having a BET surface area of less than 450 m²/g, preferably from 30 to 400 m²/g.

The person skilled in the art will know, in the light of the present description, how to adjust the formulation of the filling rubber in order to achieve the levels of properties (particularly elastic modulus) desired, and how to adapt the formulation to suit the intended specific application.

In a first embodiment of the invention, the formulation of the filling rubber can be chosen to be identical to the formulation of the rubber matrix that the cord of the invention is intended to reinforce; there will therefore be no problem of compatibility between the respective materials of the filling rubber and of the said rubber matrix.

According to a second embodiment of the invention, the formulation of the filling rubber may be chosen to differ from the formulation of the rubber matrix that the cord of the invention is intended to reinforce. Notably, the formulation of the filling rubber can be adjusted by using a relatively high quantity of adhesion promoter, typically for example from 5 to 15 phr of a metallic salt such as a cobalt or nickel salt, and advantageously reducing the quantity of the said promoter (or even omitting it altogether) in the surrounding rubber matrix. Of course, it might also be possible to adjust the formulation of the filling rubber in order to optimize its viscosity and thus its ability to penetrate the cord when the latter is being manufactured.

For preference, the filling rubber, in the crosslinked state, has a secant modulus in extension E10 (at 10% elongation) which is comprised between 2 and 25 MPa, more preferably between 3 and 20 MPa, and in particular comprised in a range from 3 to 15 MPa.

The invention of course relates to the abovementioned cord both in the uncured state (with its filling rubber then not vulcanized) and in the cured state (with its filling rubber then vulcanized). However, it is preferable for the cord of the invention to be used with a filling rubber in the uncured state until it is subsequently incorporated into the semi-finished product or finished product such as tire for which it is intended, so as to encourage bonding, during final crosslinking or vulcanizing, between the filling rubber and the surrounding rubber matrix (for example the calendering rubber).

FIG. 1 schematically depicts, in cross section perpendicular to the axis of the cord (which is assumed to be straight and at rest), one example of a preferred 1+6+12 cord according to the invention.

This cord (denoted C-1) is of the type with cylindrical layers, that is to say that its second and third layers (C2 and C3) are wound at a different pitch (p₂<p₃), preferably in the same direction (S/S or Z/Z). This type of construction has the effect that the wires (11, 12) of these second and third layers (C2, C3) form, around the core (10) or first layer (C1), two substantially concentric layers which each have a contour (E) (depicted in dotted line) which is substantially cylindrical.

The filling rubber (13) fills each capillary (14) (symbolized by a triangle) formed by the adjacent wires (considered in threes) of the various layers (C1, C2, C3) of the cord, very slightly moving these apart. It may be seen that these capillaries or gaps are naturally formed either by the core wire (10) and the wires (11) of the second layer (C2) surrounding it, or by two wires (11) of the second layer (C2) and one wire (13) of the third layer (C3) which is immediately adjacent to them, or alternatively still by each wire (11) of the second layer (C2) and the two wires (12) of the third layer (C3) which are immediately adjacent to it; thus in total there are 24 capillaries or gaps (14) present in this 1+6+12 cord.

According to a preferred embodiment, in the cord according to the invention, the filling rubber extends continuously around the second layer (C2) which it covers.

For comparison, FIG. 2 provides a reminder, in cross section, of a conventional 1+6+12 cord (denoted C-2), namely one that has not been rubberized in situ, likewise of the cylindrical layer type. The absence of filling rubber means that practically all of the wires (20, 21, 22) are in contact with one another, leading to a structure that is more compact, more difficult for rubber to penetrate from the outside.

The cord of the invention could be provided with an external wrapper, consisting for example of a single metal or non-metal thread wound in a helix around the cord at a pitch that is shorter than that of the outer layer (C3) and in a direction of winding that is the opposite of or the same as that of this outer layer. However, because of its special structure, the cord of the invention, which is already self-wrapped, does not generally require the use of an outer wrapping thread, and this advantageously solves the problems of wear between the wrapper and the wires of the outermost layer of the cord.

However, if a wrapping thread is used, in the general case where the wires of the outer layer are made of carbon steel, a wrapping thread made of stainless steel can then advantageously be chosen in order to reduce fretting wear of these carbon steel wires upon contact with the stainless steel wrapper, as taught, for example, in application WO-A-98/41682, the stainless steel wire potentially being replaced, like for like, by a composite thread only the skin of which is made of stainless steel with the core being made of carbon steel, as described for example in document EP-A-976 541. It is also possible to use a wrapper made of polyester or a thermotropic aromatic polyester-amide as described in application WO-A-03/048447.

### II-2. Manufacture of the Cord of the Invention

The abovementioned cord of the invention is suitable to be manufactured using a process involving the following steps (performed in line or otherwise):
first of all, an assembling step by twisting the N wires around the core (C1) in order to form, at a point called “assembling point”, an intermediate cord (C1+C2) called “core strand” (especially of 1+N construction when the core is formed of a single wire);
then, downstream of the assembling point, a sheathing step in which the (C1+C2) core strand is sheathed with a filling rubber in the uncured state (i.e. in the uncrosslinked state);
followed by an assembling step in which the P wires are twisted around the core strand thus sheathed;
then a final twist-balancing step.

It will be recalled here that there are two possible techniques for assembling metal wires:
either by cabling: in which case the wires undergo no twisting about their own axis, because of a synchronous rotation before and after the assembling point;
or by twisting: in which case the wires undergo both a collective twist and an individual twist about their own axis, thereby generating an untwisting torque on each of the wires and on the cord itself.

One essential feature of the above method is the use of a twisting step for each of the assembly steps above, in particular both for assembling the second layer (C2) around the core (C1) and for assembling the third layer or outer layer (C3) around the second layer (C2). Of course, if the core (C1) consists of several assembled wires, the above method also includes a step of assembling these core wires by twisting.

During the first step, the N wires of the second layer (C2) are twisted together (S or Z direction) around the core (C1) to form the core strand (C1+C2) in a way known per se; the wires are delivered by feed means such as spools, a separating grid, which may or may not be coupled to an assembling guide, intended to make the N wires converge around the core on a common twisting point (or assembling point).

The core strand (C1+C2) thus formed is then sheathed with uncured filling rubber supplied by an extrusion screw at an appropriate temperature. The filling rubber can thus be delivered at a single and small-volume fixed point by means of a single extrusion head.

This process has the advantage of making it possible for the complete operation of initial twisting, rubberizing and final twisting to be performed in line and in a single step, and to do all this at high speed. The above process can be implemented at a speed (the speed at which the cord travels along the twisting-rubberizing line) in excess of 50 m/min, preferably in excess of 70 m/min, notably in excess of 100 m/min.

However, the cord of the invention may also be manufactured in several distinct operations, conducted separately over time. The intermediate cord or core strand (C1+C2) may in particular be manufactured separately during the first assembly step, and then stored on a reel before being subjected to the other successive operations of sheathing the core strand, assembling the P wires of the third layer around the sheathed strand by twisting, and lastly of final balancing of the twists.

Downstream of the assembling point (and therefore, notably, upstream of the extrusion head), the tensile stress applied to the core strand is preferably comprised between 10 and 25% of its breaking strength.

The extrusion head may comprise one or more dies, for example an upstream guiding die and a downstream sizing die. Means for continuously measuring and controlling the diameter of the cord may be added, these being connected to the extruder. For preference, the temperature at which the filling rubber is extruded is comprised between 50° C. and 120° C., and more preferably is comprised between 50° C. and 100° C.

The extrusion head thus defines a sheathing zone having the shape of a cylinder of revolution, the diameter of which is preferably comprised between 0.15 mm and 1.2 mm, more preferably between 0.2 and 1.0 mm, and the length of which is preferably comprised between 4 and 10 mm.

Thus, the amount of filling rubber delivered by the extrusion head can easily be adjusted so that, in the final cord, this quantity is comprised between 10 and 50 mg, preferably between 15 and 50 mg, more preferably between 20 and 45 mg per g of cord.

Typically, on leaving the extrusion head, the core of the cord or core strand (C1+C2), at all points on its periphery, is covered with a minimum thickness of filling rubber which thickness preferably exceeds 5 μm, more preferably still exceeds 10 μm, and is notably comprised between 10 and 80 μm.

At the end of the preceding sheathing step, the process involves, during a third step, the final assembling, again by twisting (S or Z direction), of the P wires of the third layer or outer layer (C3) around the core strand (C1+C2) thus sheathed. During the twisting operation, the P wires come to bear against the filling rubber, becoming encrusted therein. The filling rubber, displaced by the pressure exerted by these P outer wires, then naturally has a tendency to at least partially fill each of the gaps or cavities left empty by the wires, between the core strand (C1+C2) and the outer layer (C3).

At this stage, the cord of the invention is not finished: the capillaries present inside the centre, and which are delimited by the core (C1) and the N wires of the second layer (C2), are not yet full of filling rubber, or in any event, are not full enough to yield a cord of optimal air impermeability.

The essential step which follows involves passing the cord through twist balancing means to obtain a so-called twist-balanced cord (that is to say one which is virtually free of residual twist); what is meant here by “twist balancing” is, in the known way, the cancelling out of residual twisting torques (or untwisting springback) exerted on each wire of the cord, in the second, internal, layer (C2) as in the third, outer, layer (C3). Twist balancing tools are known to those skilled in the art of twisting; they may for example consist of straighteners and/or of twisters and/or of twister-straighteners consisting either of pulleys in the case of twisters, or of small-diameter rollers in the case of straighteners, through which pulleys or rollers the cord runs.

It is assumed a posteriori that, during the passage through this balancing tool, the twist applied to the N wires of the second layer (C2) is sufficient to force or drive the still hot and relatively fluid filling rubber in the raw (i.e. uncrosslinked, uncured) state from the outside towards the core of the cord, right into the capillaries formed by the core (C1) and the N wires of the second layer (C2), ultimately giving the cord of the invention the excellent air impermeability property that characterizes it. The straightening function afforded by the use of a straightening tool would also have the advantage that contact between the rollers of the straightener and the wires of the third layer (C3) will apply additional pressure to the filling rubber, further encouraging it to penetrate the capillaries present between the second layer (C2) and the third layer (C3) of the cord of the invention.

In other words, the process described hereinabove uses the twist of the wires in the final stage of manufacture of the cord to distribute the filling rubber naturally and uniformly inside the cord, while at the same time perfectly controlling the amount of filling rubber supplied.

Thus, unexpectedly, it has proved possible to make the filling rubber penetrate into the very heart of the cord of the invention, into all of its capillaries, by depositing the rubber downstream of the point of assembly of the N wires around the core (C1), while at the same time still controlling and optimizing the amount of filling rubber delivered, thanks to the use of a single extrusion head.

After this final twist balancing step, the manufacture of the cord of the invention is complete. For preference, in this completed cord, the thickness of filling rubber between two adjacent wires of the cord, whichever these wires might be, varies from 1 to 10 μm. This cord can be wound onto a receiving spool, for storage, before for example being treated via a calendering installation, in order to prepare a metal/rubber composite fabric that can be used for example as a tire carcass reinforcement.

The method described above makes it possible to manufacture cords which may have no (or virtually no) filling rubber at their periphery. What is meant by that is that no particle of filling rubber is visible, to the naked eye, on the periphery of the cord, that is to say that a person skilled in the art would, after manufacture, see no difference, to the naked eye, from a distance of three metres or more, between a spool of cord in accordance with the invention and a spool of conventional cord that has not been rubberized in situ.

A rubberizing and assembling device that can preferably be used for implementing this method is a device comprising, from upstream to downstream in the direction of travel of a cord as it is being formed:
feed means, for, on the one hand, feeding the core (C1) and, on the other hand, feeding the N wires of the second layer (C2);
first assembling means which by twisting assemble the N wires to apply the second layer (C2) around the first layer (C1), at a point called assembling point, to form an intermediate cord called “core strand”;
downstream of the said assembling point, means of sheathing the core strand;
at the exit from the sheathing means, second assembling means which by twisting assemble the P wires around the core strand thus sheathed, in order to apply the third layer (C3);
at the exit from the second assembling means, twist balancing means.

Of course, when the core (C1) consists of several wires, the above device also includes means for assembling these core wires by twisting disposed between the means for feeding these core wires and the means for assembling the N wires of the second layer (C2).

FIG. 3 shows an example of a twisting assembling device (30), of the type having a rotating feed and a rotating receiver, that can be used for the manufacture of a cord according to the invention (p₂<p₃; same direction of twisting of the layers C2 and C3). In this device (30), feed means (310) deliver, around a single core wire (C1), N wires (31) through a distributing grid (32) (an axisymmetric distributor), which may or may not be coupled to an assembling guide (33), beyond which grid the N (for example six) wires of the second layer converge on an assembling point (34) in order to form the core strand (C1+C2) of 1+N (for example 1+6) construction.

The core strand (C1+C2), once formed, then passes through a sheathing zone consisting, for example, of a single extrusion head (35). The distance between the point of convergence (34) and the sheathing point (35) is for example comprised between 50 cm and 1 m. The P wires (37) of the outer layer (C3), of which there are for example twelve, delivered by feed means (370), are then assembled by twisting around the core strand thus rubberized (36), progressing in the direction of the arrow. The final cord (C1+C2+C3) thus formed is finally collected on the rotary receiver (19) after having passed through the twist balancing means (38) which, for example, consist of a straightener or of a twister-straightener.

As indicated previously, the core strand (C1+C2) of construction 1+N (for example 1+6) could also be prepared separately and sent directly to the entrance of the sheathing zone (35). Another possible variant, also not illustrated in FIG. 3, would be to previously rubberize the single core wire (C1) with filling rubber in sufficient quantity, by passing this core wire through the sheathing zone (35), and then to assemble the N wires (31) around the first layer (C1) thus previously sheathed by twisting. The core strand (C1+C2) thus obtained could itself be sheathed before the third layer (C3) is set in place by twisting.

### II-3. Use of the Cord in a Tire Carcass Reinforcement

As explained in the introduction to this text, the cord of the invention is particularly intended for a carcass reinforcement of a tire for an industrial vehicle.

By way of example, FIG. 4 very schematically depicts a radial section through a tire with metal carcass reinforcement that may or may not be one in accordance with the invention in this generalized depiction. This tire 1 comprises a crown 2 reinforced by a crown reinforcement or belt 6, two sidewalls 3 and two beads 4, each of these beads 4 being reinforced with a bead wire 5. The crown 2 is surmounted by a tread which has not been depicted in this schematic figure. A carcass reinforcement 7 is wound around the two bead wires 5 in each bead 4, the turned-back portion 8 of this reinforcement 7 for example being positioned towards the outside of the tire 1 which here has been depicted mounted on its rim 9. The carcass reinforcement 7 is, in a way known per se, made up of at least one ply reinforced by metal cords known as “radial” cords, which means that these cords run practically parallel to one another and extend from one bead to the other so as to form an angle comprised between 80° and 90° with the circumferential median plane (a plane perpendicular to the axis of rotation of the tire which is situated midway between the two beads 4 and passes through the middle of the crown reinforcement 6).

The tire according to the invention is characterized in that its carcass reinforcement 7 comprises at least, by way of an element for reinforcing at least one carcass ply, a metal cord according to the invention. Of course, this tire 1 further comprises, in the known way, an interior layer of rubber or elastomer (commonly known as the “inner liner”) which defines the radially internal face of the tire and is intended to protect the carcass ply from diffusion of air from the space inside the tire.

In this carcass reinforcement ply, the density of cords according to the invention is preferably comprised between 30 and 160 cords per dm (decimetre) of carcass ply, more preferably between 50 and 100 cords per dm of ply, the distance between two adjacent cords, axis to axis, preferably being comprised between 0.6 and 3.5 mm, more preferably comprised between 1.25 and 2.2 mm.

The cords according to the invention are preferably arranged in such a way that the width (denoted Lc) of the bridge of rubber between two adjacent cords is comprised between 0.25 and 1.5 mm. This width Lc represents in the known way the difference between the calendering pitch (the pitch at which the cord is laid in the rubber fabric) and the diameter of the cord. Below the indicated minimum value, the bridge of rubber, which is too narrow, carries the risk of suffering mechanical degradation when the ply is working, notably during deformations experienced in its own plane under extension or shear. Beyond the indicated maximum, the tire is exposed to risks of appearance defects arising on the sidewalls of the tires or of objects penetrating between the cords as a result of puncturing. More preferably, for these same reasons, the width Lc is chosen to be comprised between 0.35 and 1.25 mm.

For preference, the rubber composition used for the fabric of the carcass reinforcing ply has, in the vulcanized state (i.e. after curing), a secant extension modulus E10 which is comprised between 2 and 25 MPa, more preferably between 3 and 20 MPa, notably in a range from 3 to 15 MPa.

### III. EMBODIMENTS OF THE INVENTION

The following tests demonstrate the ability of the invention to provide three-layer cords which, by comparison with the in-situ-rubberized three-layer cords of the prior art, have the appreciable advantage of containing a smaller quantity of filling rubber, guaranteeing them better compactness, this rubber also being distributed uniformly within the cord, inside each of its capillaries, thus giving them optimum longitudinal impermeability.

### III-1. Manufacture of the Cords

In the following tests, layered cords of 1+6+12 construction, made up of fine brass-coated carbon-steel wires, were used.

The carbon steel wires were prepared in a known manner, for example from machine wire (diameter 5 to 6 mm) which was firstly work-hardened, by rolling and/or drawing, down to an intermediate diameter of around 1 mm. The steel used was a known carbon steel (US standard AISI 1069) with a carbon content of 0.70%. The wires of intermediate diameter underwent a degreasing and/or pickling treatment before their subsequent conversion. After a brass coating had been applied to these intermediate wires, what is called a “final” work-hardening operation was carried out on each wire (i.e. after the final patenting heat treatment) by cold-drawing in a wet medium with a drawing lubricant for example in the form of an aqueous emulsion or dispersion. The brass coating surrounding the wires had a very small thickness, markedly lower than 1 micron, for example of the order of 0.15 to 0.30 μm, which is negligible by comparison with the diameter of the steel wires.

The steel wires thus drawn had the following diameters and mechanical properties:

TABLE 1

| Steel | φ (mm) | Fm (N) | Rm (MPa) |
|---|---|---|---|
| NT | 0.18 | 68 | 2820 |
| NT | 0.20 | 82 | 2620 |

These wires were then assembled in the form of 1+6+12 layered cords the construction of which is as shown in FIG. 1 and the mechanical properties of which are given in Table 2.

TABLE 2

| | p₂ | p₃ | Fm | Rm | At |
|---|---|---|---|---|---|
| Cord | (mm) | (mm) | (daN) | (MPa) | (%) |
| C-1 | 7 | 10 | 125 | 2650 | 2.4 |

The 1+6+12 cord of the invention (C-1), as depicted schematically in FIG. 1, is therefore made up of 19 wires in total, a core wire of diameter 0.20 mm and 18 wires around it, all of diameter 0.18 mm, which have been wound in two concentric layers in the same direction of twist (S/S). The filling rubber content, measured using the method indicated above at paragraph I-3, was about 30 mg per g of cord. This filling rubber was present in each of the 24 capillaries formed by the various wires considered in threes, i.e. it completely or at least partly filled each of these capillaries such that, over any 2 cm length of cord, there was at least one plug of rubber in each capillary.

To manufacture this cord, use was made of a device as described hereinabove and schematically depicted in FIG. 3. The filling rubber was a conventional rubber composition for the carcass reinforcement of a tire for industrial vehicles, having the same formulation as the rubber carcass ply that the cord C-1 was intended to reinforce; this composition was based on natural (peptized) rubber and on N330 carbon black (55 phr); it also contains the following usual additives: sulphur (6 phr), sulfenamide accelerator (1 phr), ZnO (9 phr), stearic acid (0.7 phr), antioxidant (1.5 phr), cobalt naphthenate (1 phr); the E10 modulus of the composition was around 6 MPa. This composition was extruded at a temperature of around 65° C. through a sizing die measuring 0.580 mm.

### III-2. Air Permeability Tests

The cords C-1 of the invention were subjected to the air permeability test described at paragraph I-2, measuring the volume of air (in cm³) passing through the cords in 1 minute (average over 10 measurements for each cord tested).

For each cord C-1 tested and for 100% of the measurements (i.e. ten specimens out of ten), a flow rate of zero or of less than 0.2 cm³/min was measured; in other words, the cords of the invention can be termed airtight along their longitudinal axis; they therefore have an optimum level of penetration by the rubber.

Furthermore, control cords rubberized in situ and of the same construction as the compact cords C-1 of the invention were prepared in accordance with the method described in the aforementioned application WO 2005/071557, in several discontinuous steps, sheathing the intermediate 1+6 core strand using an extrusion head, then in a second stage cabling the remaining 12 wires around the core thus sheathed, to form the outer layer. These control cords were then subjected to the air permeability test of paragraph I-2.

It was noted first of all that none of these control cords gave 100% (i.e. ten specimens out of ten) measured flow rates of zero or less than 0.2 cm³/min, or in other words that none of these control cords could be termed airtight (completely airtight) along its axis.

It was also found that, of these control cords, those which exhibited the best impermeability results (i.e. an average flow rate of around 2 cm³/min) all had a relatively large amount of unwanted filling rubber overspilling from their periphery, making them ill suited to a satisfactory calendering operation under industrial conditions.

Of course, the invention is not limited to the embodiments described hereinabove.

Thus, for example, the core (C1) of the cords of the invention could consist of a wire of non-circular section, for example one that has been plastically deformed, notably a wire of substantially oval or polygonal, for example triangular, square or even rectangular, cross section; the core could also be made of a preformed wire, of circular cross section or otherwise, for example a wire that is wavy, twisted, or contorted into the shape of a helix or a zigzag. In such cases, it must of course be appreciated that the diameter d₁ of the core (C1) represents the diameter of the imaginary cylinder of revolution surrounding the central wire (the envelope diameter) rather than the diameter (or any other transverse dimension if the cross section is non-circular) of the central wire itself.

For reasons of industrial feasibility, cost and overall performance, it is, however, preferable for the invention to be implemented with a single central wire (layer C1) that is conventional, linear and of circular cross section.

Further, because the central wire is less stressed during operation of the cabling than are the other wires, given its position in the cord, it is not necessary for this wire to be made using, for example, steel compositions that offer high torsional ductility; advantageously, use may be made of any type of steel, for example a stainless steel.

Furthermore, one (at least one) linear wire of one of the other two layers (C2 and/or C3) could likewise be replaced by a preformed or deformed wire or, more generally, by a wire of a cross section different from that of the other wires of diameter d₂ and/or d₃, so as, for example, to further improve the penetrability of the cord by the rubber or any other material, it being possible for the envelope diameter of this replacement wire to be less than, equal to or greater than the diameter (d₂ and/or d₃) of the other wires that make up the relevant layer (C2 and/or C3).

Without altering the spirit of the invention, some of the wires that make up the cord according to the invention could be replaced by wires other than steel wires, metallic or otherwise, and could notably be wires or threads made of an inorganic or organic material of high mechanical strength, for example monofilaments made of liquid crystal organic polymers.

The invention also relates to any multiple strand steel cord (“multi-strand rope”) the structure of which incorporates at least, by way of elementary strand, a layered cord according to the invention.

By way of example of multi-strand ropes according to the invention, which can be used for example in tires for industrial vehicles of the civil engineering type, notably in their carcass or crown reinforcement, mention may be made of multi-strand ropes with two layers known per se of the following overall constructions, for example:
(1+5)×(1+N+P) made up in total of six elementary strands, one at the centre and the other five cabled around the centre;
(1+6)×(1+N+P) made up in total of seven elementary strands, one at the centre and the other six cabled around the centre;
(2+7)×(1+N+P) made up in total of nine elementary strands, two at the centre and the other seven cabled around the centre;
(2+8)×(1+N+P) made up in total of ten elementary strands, two at the centre and the other eight cabled around the centre;
(3+8)×(1+N+P) made up in total of eleven elementary strands, three at the centre and the other eight cabled around the centre;
(3+9)×(1+N+P) made up in total of twelve elementary strands, three at the centre and the other nine cabled around the centre;
(4+9)×(1+N+P) made up in total of thirteen elementary strands, three at the centre and the other nine cabled around the centre;
(4+10)×(1+N+P) made up in total of fourteen elementary strands, four at the centre and the other ten cabled around the centre,
   but in which each elementary strand (or, at the very least, at least part of them) is made up of a 1+N+P, notably 1+6+11 or 1+6+12, three-layered cord which is in accordance with the invention.

Such multi-strand steel ropes, notably of the types (1+5)×(1+6+11), (1+6)×(1+6+11), (2+7)×(1+6+11), (2+8)×(1+6+11), (3+8)×(1+6+11), (3+9)×(1+6+11), (4+9)×(1+6+11), (4+10)×(1+6+11), (1+5)×(1+6+12), (1+6)×(1+6+12), (2+7)×(1+6+12), (2+8)×(1+6+12), (3+8)×(1+6+12), or (3+9)×(1+6+12), (4+9)×(1+6+12) or (4+10)×(1+6+12), may themselves be rubberized in situ at the time of their manufacture, that is to say in this case the central strand is itself, or the strands of the centre if there are several thereof are themselves, sheathed with the non-vulcanized filling rubber during their manufacture, before the peripheral strands forming the outer layer are set in place by cabling.

1. A metal cord with three layers, which is rubberized in situ, comprising a core or first layer of diameter d₁, around which there are wound together in a helix at a pitch p₂, in a second layer, N wires of diameter d₂, around which there are wound together in a helix at a pitch p₃, in a third layer, P wires of diameter d₃, wherein the cord has the following characteristics (d₁, d₂, d₃, p₂ and p₃ being expressed in mm):
0.08≦d₁≦0.50;
0.08≦d₂≦0.45;
0.08≦d₃≦0.45;
5.1π(d₁+d₂)<p₂<p₃<4.9π(d₁+2d₂+d₃);
over any 2 cm length of cord, a rubber composition called “filling rubber” is present in each of the capillaries lying on the one hand between the core and the N wires of the second layer, and on the other hand between the N wires of the second layer and the P wires of the third layer;
the content of filling rubber in the cord is comprised between 10 and 50 mg per gram of cord.

2. The cord according to claim 1, wherein the rubber of the filling rubber is a diene elastomer.

3. The cord according to claim 2, wherein the diene elastomer is chosen from the group consisting of polybutadienes, natural rubber, synthetic polyisoprenes, copolymers of butadiene, copolymers of isoprene, and blends of these elastomers.

4. The cord according to claim 3, wherein the diene elastomer is an isoprene elastomer, preferably natural rubber.

5. The cord according to claim 1, wherein the following characteristics are satisfied (with d₁, d₂, d₃ being in mm):
0.10≦d₁≦0.40;
0.10≦d₂≦0.35;
0.10≦d₃≦0.35.

6. The cord according to claim 1, wherein the following characteristics are satisfied:
for N=5: 0.6<(d₁/d₂)<0.9;
for N=6: 0.9<(d₁/d₂)<1.3;
for N=7: 1.3<(d₁/d₂)<1.6.

7. The cord according to claim 1, wherein the N and P wires of the second and third layers are wound in the same direction of twisting.

8. The cord according to claim 1, wherein p₂ and p₃ are comprised in a range from 5 to 30 mm.

9. The cord according to claim 1, wherein d₂=d₃.

10. The cord according to claim 1, wherein the second layer comprises 5, 6 or 7 wires.

11. The cord according to claim 1, wherein the third layer comprises 10 to 14 wires.

12. The cord according to claim 1, wherein the third layer is a saturated layer.

13. The cord according to claim 1, wherein the core consists of a single wire.

14. The cord according to claim 13, of 1+6+11 or 1+6+12 construction.

15. The cord according to claim 1, wherein the content of filling rubber is comprised between 15 and 50 mg per g of cord.

16. The cord according to claim 1, wherein, in an air permeability test (according to paragraph I-2), it has an average air flow rate of less than 2 cm³/min.

17. The cord according to claim 16, wherein, in the air permeability test (according to paragraph I-2), it has an air flow rate less than or at the most equal to 0.2 cm³/min.

18. A multi-strand rope at least one of the strands of which is a cord according to claim 1.

19. (canceled)

20. (canceled)

21. A tire comprising a cord according to claim 1.

22. The tire according to claim 21, said tire being a tire of an industrial vehicle.

23. The tire according to claim 21, the cord being present in the carcass reinforcement of the tire.
